(19) United States
(12) Patent Application Publication
(10) Pub. No.: US 2020/0326021 A1
(43) Pub. Date: Oct. 15, 2020

(54) HOSE CONNECTOR

(71) Applicant: SHIN TAI SPURT WATER OF THE GARDEN TOOLS CO., LTD., LU-KANG TOWN (TW)

(72) Inventor: Chin-Yuan Chen, LU-KANG TOWN (TW)

(21) Appl. No.: 16/384,754

(22) Filed: Apr. 15, 2019

(51) Int. Cl. F16L 19/02; F16L 15/00

(52) U.S. Cl. CPC F16L 19/0218; F16L 15/006

(57) ABSTRACT

A faucet connector has a first tubular body is provided with an assembly aperture, and the first tubular body is convexly disposed on the inner wall of the assembly aperture. A second tubular body is formed with an inserting portion at one end, and the inserting portion is penetrated by an inner threaded aperture. The second tubular body is disposed at the assembly aperture. A third tubular body is formed with a ring at one end, the third tubular body has a threaded portion at the other end, and the third tubular body is placed at the first tubular body inside the assembly aperture of the tubular body. The threaded portion of the third tubular body is locked to the inner threaded hole of the second tubular body, so that the ring fits the inserting portion at both ends of the lip.

### BACKGROUND of INVENTION

### Field of Invention

The present invention relates to a hose connector, and more particularly to a rotatable hose connector.

### Description of the Related Art

Conventional connectors for a water spray gun are generally two types. One is a connecting joint that cannot rotate between a water supply resource and a water pipe. Therefore, the external force may cause the water pipe to form a twist or wind, so the water pipe is often entangled. That can cause impediment of the water spray operation and will also increase the water pressure inside the water pipe due to the resistance caused by the knotting and winding, making the water pipe easy to burst or the water pipe itself may be detached from the water supply resource. Another one is rotatable between the two ends of the water supply resource and the water pipe. The connector is composed of three or more tubes, and a plurality of steel balls are arranged between the tubes to achieve the rotation. However, the connector is not easy to assemble, and it will increase the risk of leaks and jam.

Therefore, it is desirable to provide a rotatable hose connector to mitigate and/or obviate the aforementioned problems.

### SUMMARY OF THE INVENTION

An objective of present invention is to provide a hose connector, which is capable of improving the above-mention problems.

In order to achieve the above mentioned objective, A faucet connector has a first tubular body is provided with an assembly aperture, and the first tubular body is convexly disposed on the inner wall of the assembly aperture. A second tubular body is formed with an inserting portion at one end, and the inserting portion is penetrated by an inner threaded aperture. The second tubular body is disposed at the assembly aperture. A third tubular body is formed with a ring at one end, the third tubular body has a threaded portion at the other end, and the third tubular body is placed at the first tubular body inside the assembly aperture of the tubular body. The threaded portion of the third tubular body is locked to the inner threaded hole of the second tubular body, so that the ring fits the inserting portion at both ends of the lip.

Other objects, advantages, and novel features of invention will become more apparent from the following detailed description when taken in conjunction with the accompanying drawings.

### BRIEF DESCRIPTION OF DRAWINGS

FIG. 1 is a perspective view of a preferred embodiment according to the present invention.

FIG. 2 is an exploded view of the preferred embodiment according to the present invention.

FIG. 3 is a schematic drawing of the state of use of the preferred embodiment according to the present invention.

FIG. 4 is a cross-sectional view of the preferred embodiment according to the present invention.

FIG. 5 is a schematic drawing of the rotation action of the preferred embodiment according to the present invention.

### DETAILED DESCRIPTION OF THE PREFERRED EMBODIMENT

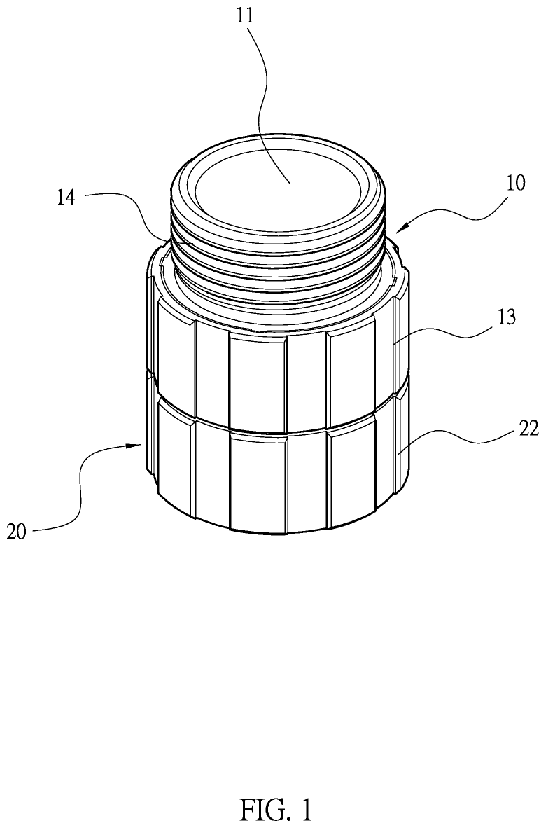

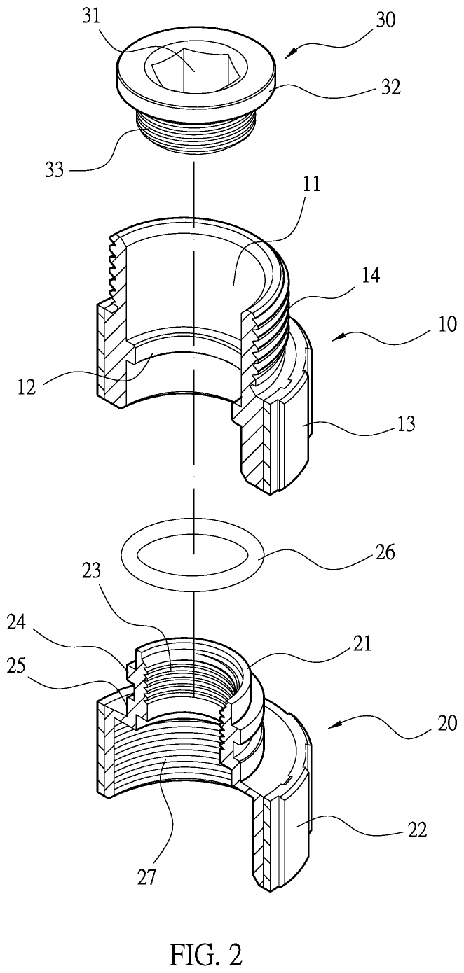

Please refer to FIGS. 1-3. A hose connector comprises: a first tubular body 10, a second tubular body 20 and a third tubular body 30. The first tubular body 10 has an assembly aperture 11 with a lip 12 at an inner wall and a first neck potion 13 at one end. The first tubular body 10 further comprises an outer threaded portion 14 at one end opposite the first neck potion 13. The outer threaded portion 14 is configured for being connected to a spray gun A. Furthermore, the first neck potion 13 allows a user to rotate the first tubular body 10, and the outer threaded portion 14 is screwed onto the spray gun A. The second tubular body 20 has an inserting portion 21 at one end, and a second neck portion 22 at another end. The inserting portion 21 has an inner threaded aperture 23 and disposed in the assembly aperture 21 of the first tubular body 10. The inserting portion 21 of the second tubular body 20 further comprises a stopping ring 24 stopping the lip 12 of the first tubular body 10. The inserting portion 21 further comprises a neck portion 25, and a sealing ring 26 is mounted between the neck portion 25 and the stopping ring 24 and pushes against the inner wall of the assembly aperture 11 of the first tubular body 10. The second neck portion 22 of the second tubular body 20 further has a connecting screw hole 27, and the connecting screw hole 27 is connected to the inner threaded hole 23. The second neck portion 22 can be rotatable by the user, and the connecting screw hole 27 is connected to an external hose B and the third tubular body 30. The third tubular body 30 comprise a hexagonal through hole 31. Moreover, the third tubular body 30 has a, a ring 32 at one end, and a threaded portion 33 at another end. The third tubular body 30 is disposed in the assembly aperture 11 of the first tubular body 10 and the threaded portion 33 of the third tubular body 30 engages with the inner threaded hole 23 of the second tubular body 20. The ring 32 and the inserting portion 21 respectively abut two sides of the lip 12 to enable a relative rotation between the first tubular body 10 and the second tubular body 20, which can prevent the spray gun A and external hose B twist with each other.

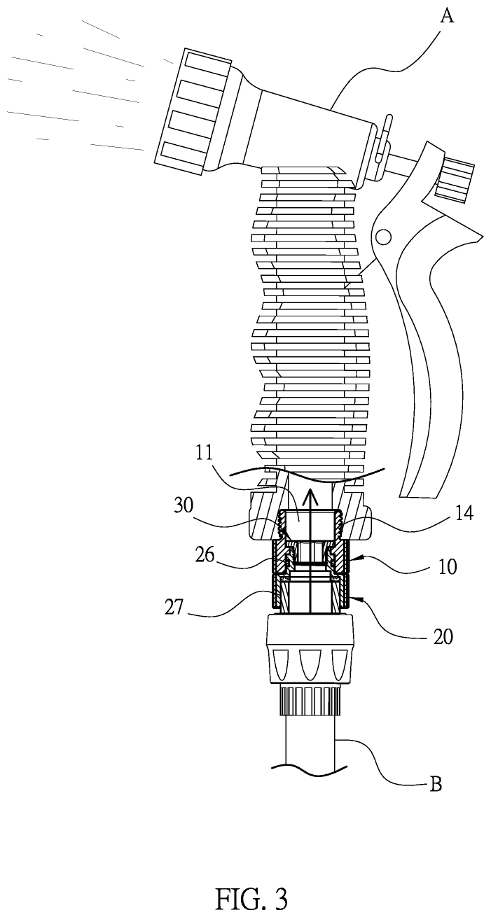

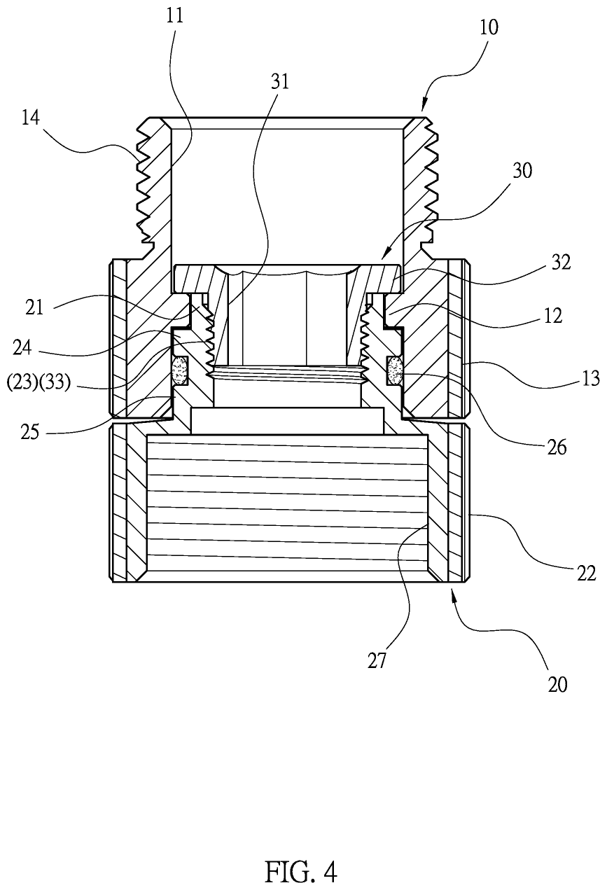

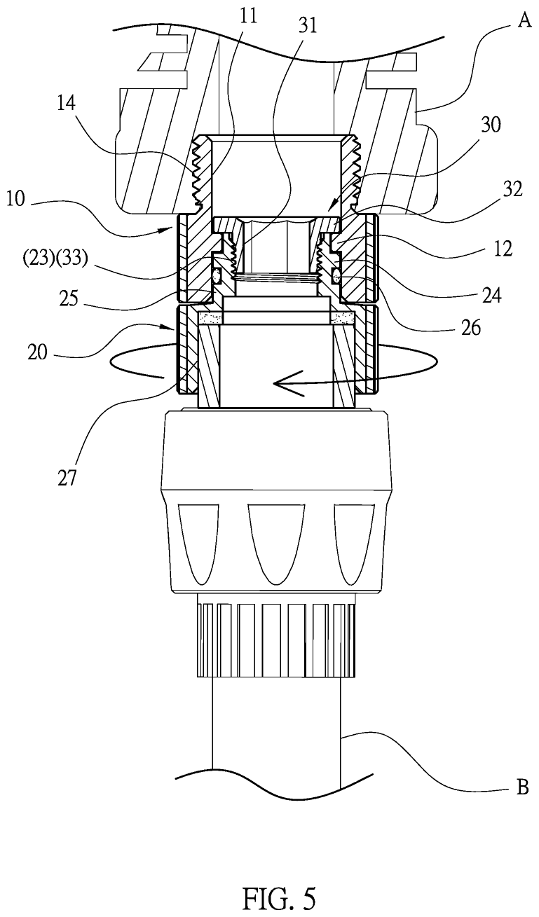

The effect of the actual use, as shown in FIGS. 3, 4, and 5. The second tubular body 20 is provided with the sealing ring 26 between the stopping ring 24 and the neck portion 25, and the inserting portion 21 of the second tubular body 20 is inserted into the assembly aperture 11 through the one end of the first tubular body 10 with the first neck body 13. Afterward, the stopping ring 24 is in contact with one end of the first tubular body 10 having the lip 12, the sealing ring 26 is in contact with the inner wall of the assembly aperture 11, and the third tubular body 30 is placed into the assembly aperture 11 by one end having the outer threaded portion 14, so that the threaded portion 33 of the third tubular body 30 is screwed to the inner threaded hole 23 of the second tubular body 20. Furthermore, the ring 32 and the stopping ring 24 are blocked at both ends of the lip 12, and the assembly aperture 11 of the first tubular body 10 connects to the second tubular body 20 via the through hole 31. The first tubular body 10 is connected to the water spray gun A, a pipe or a water gun connected to the water pipe by the outer threaded portion 14, and the second tubular body 20 is connected to the water pipe B via the connecting screw hole 27. When the water flows, the water flow can be sequentially starts from the second tubular body 20, the third tubular body 30 and the first tubular body 10 then into the water spray gun A, so the water spray gun A is able to perform the water spray operation. When the water spray action causes the water spray gun A and the water pipe B to rotate or twist each other, since the second tubular body 20 and the third tubular body 30 are placed at the two opposite ends of the lip 12 respectively with the stopping ring 24 and the ring 32, the second tubular body 20 and the third tubular body 30 are be able to rotate against the lip 12 simultaneously. Therefore, rotation or swing of the spray gun A will not drive the water pipe B, thereby preventing the occurrence of twisting or winding between the water spray gun A and the water pipe B and improving the convenience of water operation.

Although the present invention has been explained in relation to its preferred embodiment, it is to be understood that many other possible modifications and variations can be made without departing from the spirit and scope of invention as hereinafter claimed.

What is claimed is:

1. A faucet connector comprising:
a first tubular body having an assembly aperture with a lip at an inner wall and a the first neck potion at one end;
a second tubular body having an inserting portion at one end, and a second neck portion at another end, the inserting portion having an inner threaded aperture and disposed in the assembly aperture of the first tubular body; and
a third tubular body having a through hole, a ring at one end, and a threaded portion at another end, the third tubular body disposed in the assembly aperture of the first tubular body and the threaded portion of the third tubular body engaging with the inner threaded hole of the second tubular body, the ring and the inserting portion respectively abutting two sides of the lip to enable a relative rotation between the first tubular body and the second tubular body.

2. The faucet connector as claimed in claim 1, wherein the first tubular body further comprises an outer threaded portion at one end opposite the first neck potion.

3. The faucet connector as claimed in claim 1, wherein the second neck portion of the second tubular body further comprises a connecting screw hole connected to the inner threaded hole and configured to connect to an external hose.

4. The faucet connector as claimed in claim 1, wherein the inserting portion of the second tubular body further comprises a stopping ring stopping the lip of the first tubular body.

5. The faucet connector as claimed in claim 4, wherein the inserting portion further comprises a neck portion, and a sealing ring is mounted between the neck portion and the stopping ring and pushes against the inner wall of the assembly aperture of the first tubular body.

6. The faucet connector as claimed in claim 1, wherein the through hole of the third tubular body is hexagonal.
